(19) United States
(12) Patent Application Publication
(10) Pub. No.: US 2008/0127161 A1
(43) Pub. Date: May 29, 2008

(54) Environment state changes to alter functionality

(75) Inventors: Yusuf Atas, Redmond, WA (US); Mukesh Karki, Issaquah, WA (US); Egor Nikitin, Bellevue, WA (US); Narayanan Parthasarathy, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/581,724

(22) Filed: Oct. 16, 2006

(51) Int. Cl. G06F 9/44; G06F 1/24; G06F 9/00

(52) U.S. Cl. 717/168; 713/100

(57) ABSTRACT

In an embodiment, environmental functionality of the system software may be changed by altering guarded system data which may affect behavior of the system software. A user may provide state change information for altering a state of the system software, which may thereby alter the environmental functionality of the system software. In some implementations, the state change information may include a product key or any alternative activation/identification datum. The guarded system data may be altered based on the state change information. Upon startup or after detecting altered guarded system data, the system software may set configuration parameters, based on the altered guarded system data or a detected hardware configuration, to enable a particular environmental functionality of the system software.

### BACKGROUND

Typically, when a user upgrades system software such as, for example, an operating system, the user is required to have a physical storage medium, such as, for example, a compact disc (CD) or other storage medium, which may include a number of files, including configuration settings, binary files and applicable resources. During the upgrade process, various system attributes may be deleted including, but not limited to, registry settings and binary files of the system software. Further, during the upgrade process binary files may be deposited onto a medium of a processing device and registry settings and registers, as well as other components may be updated.

Environment functionality of the system software may include a number of factors that affect a user's experience. For example, environment functionality may include, for example, a type of user interface (graphical or otherwise) and services provided (or not provided) by the system software. The environment functionality of the system software may be affected by a particular type of technology included in a processing device in which the system software is executing, network connectivity, the user's technological sophistication (or lack there of), as well as other factors. In most cases, the system software such as, for example, an operating system, may include a particular environment functionality, which may not be downgraded from a higher-version to a lower-version. Typically, only upgrades to the system software are possible. For example, if the user wishes to scale back complexity of the system, either temporarily, permanently or based on the user's proficiency with the system, there is no way to accomplish this.

### SUMMARY

This Summary is provided to introduce a selection of concepts in a simplified form that is further described below in the Detailed Description. This summary is not intended to identify key features or essential features of the claimed subject matter, nor is it intended to be used to limit the scope of the claimed subject matter.

System software such as, for example, an operating system may include numerous software modules related to various functions and/or services of the operating system, which may include a user's feel or experience, as well as one or more services, which may be provided to the user. Environmental functionality of the system software may include a number of aspects related to the system software such as, for example, functions and services provided, and a user's experience or feel of the system software.

In embodiments consistent with the subject matter of this disclosure, environmental functionality of the system software may be changed, for example, upgraded (increased) or downgraded (decreased), by altering guarded system data which may affect behavior of the system software. In some embodiments, the guarded system data may include guarded system configuration information such as, for example, one or more binary files, multiple sets of software/hardware parameters, or other system data. In one embodiment, a user may provide state change information for altering a state of the system software, which may thereby alter the environmental functionality of the system software. In some embodiments, the state change information may include a product key, or any alternative activation/identification datum. The state change information may be used to alter the guarded system data. The system software may set configuration parameters, based on the altered guarded system data, to enable a particular environmental functionality of the system software. In some embodiments, the system software may detect a hardware configuration of a processing device executing the system software. In such embodiments, the particular environmental functionality of the system software may be based on at least one of the altered guarded system data or the detected hardware configuration of the processing device.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates a functional block diagram of an exemplary processing device which may implement embodiments consistent with the subject matter of this disclosure.

FIG. 2 illustrates a flowchart of an exemplary process which may be performed in embodiments consistent with the subject matter of this disclosure.

FIG. 3 shows a flowchart of an exemplary process, which is a variation of the exemplary process shown in FIG. 2.

FIG. 4 illustrates a flowchart of an exemplary process which may be performed by system software upon startup.

FIG. 5 illustrates a flowchart of an exemplary process which may be performed by system software upon startup in another embodiment consistent with the subject matter of this disclosure.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure.

### Exemplary Processing Device

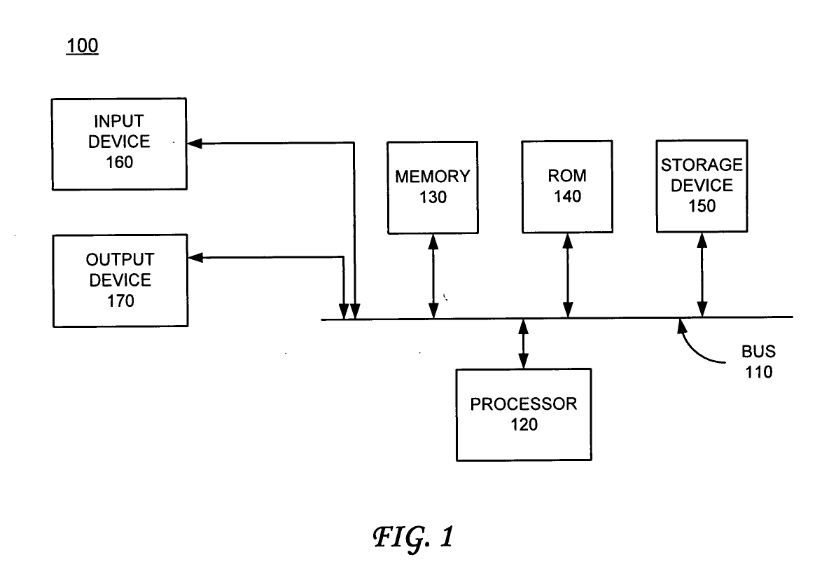

FIG. 1 is a functional block diagram which illustrates an exemplary processing device 100, which may be used in implementations consistent with the subject matter of this disclosure. Processing device 100 may include a bus 110, a processor 120, a memory 130, a read only memory (ROM) 140, a storage device 150, an input device 160, and an output device 170. Bus 110 may permit communication among components of processing device 100.

Processor 120 may include at least one conventional processor or microprocessor that interprets and executes instructions. Memory 130 may be a random access memory (RAM) or another type of dynamic storage device that stores information and instructions for execution by processor 120. Memory 130 may also store temporary variables or other intermediate information used during execution of instructions by processor 120. ROM 140 may include a conventional ROM device or another type of static storage device that stores static information and instructions for processor 120. Storage device 150 may include any type of media for storing data and/or instructions.

Input device 160 may include one or more conventional mechanisms that permit a user to input information to processing device 100, such as, for example, a keyboard, a mouse, or other input device. Output device 170 may include one or more conventional mechanisms that output information to the user, including a display, a printer, or other output device. Communication interface 180 may include any transceiver-like mechanism that enables processing device 100 to communicate with other devices or networks. In one embodiment, communication interface 180 may include an interface to network 106.

Processing device 100 may perform such functions in response to processor 120 executing sequences of instructions contained in a computer-readable medium, such as, for example, memory 130, or other medium. Such instructions may be read into memory 130 from another computer-readable medium, such as storage device 150, or from a separate device via a communication interface (not shown).

### Overview

Embodiments consistent with the subject matter of this disclosure relate to altering a state of system software such as, for example, an operating system, to change environmental functionality of the system software. In one implementation, system software such as, for example, an operating system may include numerous software modules related to various functions and/or services of the operating system, which may include a user's feel or experience, as well as one or more services, which may be provided to the user. Services which may or may not be provided may include, for example, network services, such as sharing of resources over a network, or other services. Environmental functionality of the system software may include a number of aspects related to the system software such as, for example, functions and services provided, and a user's experience or feel of the system software.

In various implementations, environmental functionality of the system software may be changed, for example, upgraded or downgraded, by altering system data within the system software. The system data may include system configuration information such as, for example, one or more binary files, multiple sets of software/hardware parameters, or other system data. The system data may be protected or guarded from alteration. In one implementation, a user may provide state change information for altering a state of the system software, which may thereby alter the environmental functionality of the system software. In some embodiments, the state change information may include a product key or a similar activation datum. Other forms of the state change information may be used in other embodiments consistent with the subject matter of this disclosure. The state change information may be used to alter the guarded system data. After altering the guarded system data, the system software may be restarted. In some embodiments, the system software may detect changes to the guarded system data and may make changes to the environmental functionality of the system software without restarting. After restarting, or after detecting the changes to the guarded system data, the system software may set configuration parameters, based on the altered guarded system data, to enable a particular environmental functionality of the system software. In some embodiments, the system software may detect a hardware configuration of a processing device executing the system software. In such embodiments, the particular environmental functionality of the system software may be based on at least one of the altered guarded system data or the detected hardware configuration of the processing device.

### Exemplary Methods

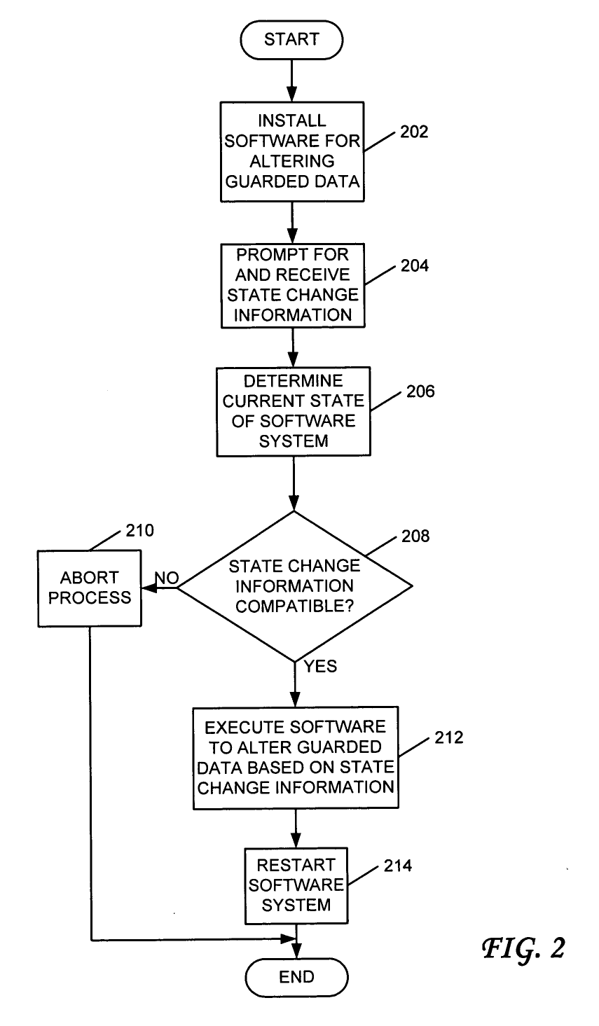

FIG. 2 is a flowchart illustrating an exemplary process that may be implemented in embodiments consistent with the subject matter of this disclosure. The process may begin by installing software for altering guarded data such as, for example, system data, on a processing device such as, for example, processing device 100 (act 202). The software for altering the guarded data may be copied to the processing device from a storage medium such as, for example, a compact disc (CD), a flash RAM device, a floppy disk, or other storage media. Alternatively, the software for altering the guarded data may be downloaded to the processing device via a network. Further, in some embodiments, the software for altering the guarded data may be preinstalled on the processing device. In such an embodiment, act 202 need not be performed.

The processing device may then execute the software for altering the guarded data, which may prompt a user to enter state change information and may receive the state change information from the user (act 204). In one embodiment, the state change information may include a product key, which may be a code including a group of letters, digits, and/or special characters. In other embodiments, the state change information may include an alternative activation/identification datum. The processing device may then determine a current state of the system software (act 206). This may be accomplished by determining content of the guarded data of the system software, by checking content of a current product key, an activation/identification datum, or via a number of other methods.

The processing device may then compare the provided state change information with the current state of the system software to determine whether the state change information is compatible with the current state of the system software (act 208). For example, assume that the system software is an operating system called OS-Basic with a particular environmental functionality and the state change information indicates that the environmental functionality of the operating system is to be changed to be equivalent to an environmental functionality of an operating system called OS-Complex. If such a change is permitted, then the processing device may determine that the state change information is compatible. However, if the processing device executes the OS-Basic operating system and the state change information indicates that the environmental functionality of the operating system is to be changed be equivalent to an environmental functionality of an operating system called OS-Advanced, and such a change in the environmental functionality of the operating system is not permitted from the OS-Basic operating system, then the processing device may determine that the state change information is incompatible with the current state of the system software.

If, during act 208, the processing device determines that the state change information is not compatible with the current state of the system software, then the processing device may abort the process (act 210). If, during act 208, the processing device determines that the state change information is compatible with the current state of the system software, then processing device may execute the software to alter the guarded data based on the state change information (act 212). In some embodiments consistent with the subject matter of this disclosure, the software to alter the guarded data may be include in an operating system such as, for example, a very basic operating system. Alteration of the guarded data may include modification of registry keys, or other protected data which may affect the behavior of the operating system. After altering the guarded data, the processing device may then cause the system software to restart or reboot (act 214). In some embodiments, the system software may detect changes to the guarded data and may make changes to the environmental functionality of the system software without restarting.

In embodiments consistent with the subject matter of this disclosure, the exemplary process illustrated in FIG. 2 may permit environmental functionality of the system software such as, for example, an operating system, to be upgraded or downgraded by a user without introducing new or changed executable files with respect to the system software. In such an embodiment, the system software may include executable files, or binaries for executing the system software with a number of different environmental functionalities. The particular environmental functionality of the system software may be based on content of the guarded data of the system software. Thus, which portions of the system software are executed and which paths of the system software code are executed may be determined by the content of the guarded data of the system software.

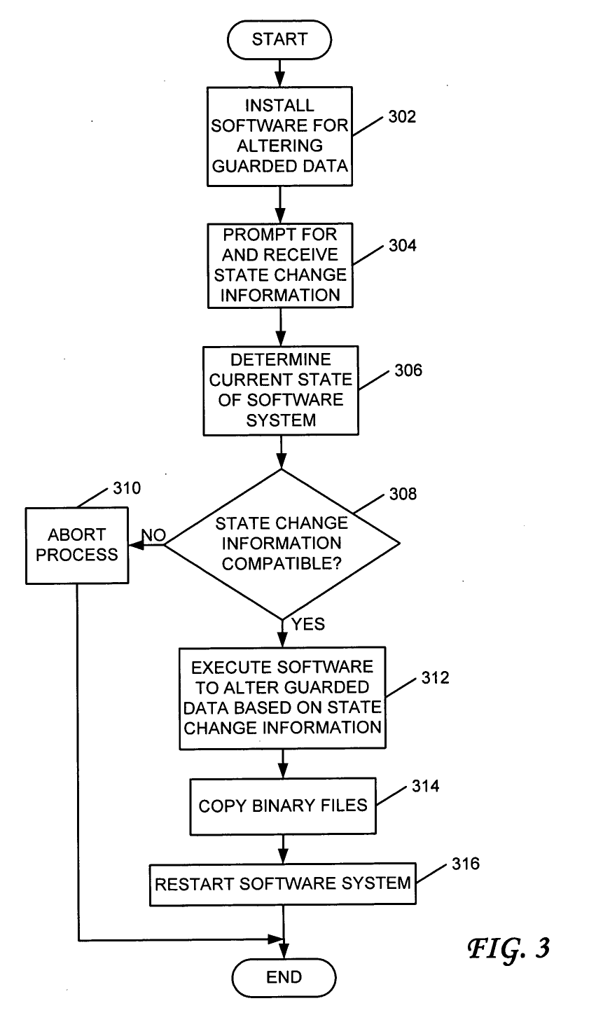

FIG. 3 is a flowchart illustrating a variation of the exemplary process of FIG. 2 that may be implemented in embodiments consistent with the subject matter of this disclosure. The process may begin by installing software for altering guarded data such as, for example, system data, on a processing device such as, for example, processing device 100 (act 302). The software for altering the guarded data may be copied to the processing device from a storage medium such as, for example, a compact disc (CD), a flash RAM device, a floppy disk, or other storage media. Alternatively, the software for altering the guarded data may be downloaded to the processing device via a network. In some embodiments, the software for altering the guarded data may be preinstalled on the processing device executing the system software. In such embodiments, act 302 need not be performed.

The processing device may then execute the installed software, which may prompt a user to enter state change information and may receive the state change information (act 304). In one embodiment, the state change information may include a product key, which may be a code including a group of letters, digits, and/or special characters. In other embodiments, the state change information may include an alternative activation/identification datum.

The processing device may then determine a current state of the system software (act 306). This may be accomplished by determining content of the guarded data of the system software, by checking content of a current product key, an activation/identification datum, or via a number of other methods.

The processing device may then compare the provided state change information with the current state of the system software to determine whether the state change information is compatible with the current state of the system software (act 308).

If, during act 308, the processing device determines that the state change information is not compatible with the current state of the system software, then the processing device may abort the process (act 310). If, during act 308, the processing device determines that the state change information is compatible with the current state of the system software, then processing device may execute the software to alter the guarded data based on the state change information (act 312). As mentioned with respect to FIG. 2, alteration of the guarded data may include modification of registry keys, or other protected data which may affect the behavior of the operating system. The processing device may then copy one or more binary or executable files to a storage medium of the processing device (act 314). The binary or executable files may be copied from the same storage medium that includes the software for altering the guarded data, may be copied from a different storage medium, or may be downloaded from another processing device via a network. The binary or executable files may include new code for the system software. The processing device may then cause the system software to restart or reboot (act 316). In some embodiments, the system software may detect changes to the guarded data and may make changes to the environmental functionality of the system software without restarting. In such embodiments, act 316 need not be performed.

In embodiments consistent with the subject matter of this disclosure, the exemplary process illustrated in FIG. 3 may permit environmental functionality of the system software such as, for example, an operating system, to be upgraded or downgraded by a user. The exemplary process illustrated in FIG. 3 may introduce new executable files to the system software. By not deleting any binary or executable files not required by a particular environmental functionality of the system software, embodiments consistent with the subject matter of this disclosure may permit a previously used environmental functionality of the system software to be used at a later time if the processing device later re-executes either the exemplary process of FIG. 2 or FIG. 3 and if the state change information is compatible with the current state of the system software. As previously mentioned with respect to FIG. 2, which portions of the system software are executed and which paths of the system software code are executed may be determined by the content of the guarded data of the system software.

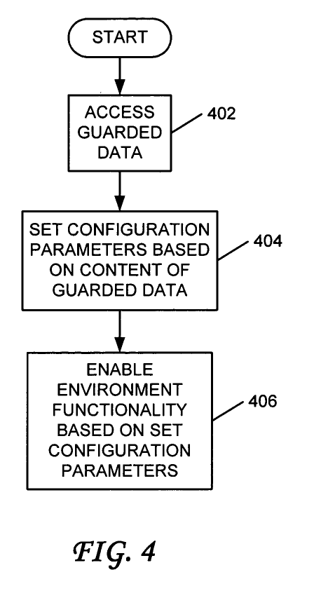

FIG. 4 illustrates a flowchart of an exemplary process that may be performed via system software executing on a processing device such as, for example, processing device 100, upon startup or after having been restarted after performing act 214 or 316. In embodiments in which the system software may detect changes to the guarded data without restarting, the processing device executing the system software may perform the exemplary process illustrated in FIG. 4 after the system software detects the changes to the guarded data. The processing device executing the system software may access the guarded data (act 402). In one embodiment, the processing device executing the system software may access registry keys, which may indicate a desired behavior and/or a desired set of services of the system software. The processing device executing the system software may then set configuration parameters of the system software based on content of the guarded data (act 404). In an embodiment, the processing device may set configuration parameters such as, for example, registry keys or other configuration parameters which may affect behavior of the system software and services provided by the system software.

Next, the processing device may enable a particular environment functionality based on the set configuration parameters (act 406). In an embodiment, the processing device executing the system software may accomplish this by enabling a particular set of services, and/or a particular user interface or user interface experience. For example, services which provide for sharing of network resources may be enabled in the particular environment functionality of the system software.

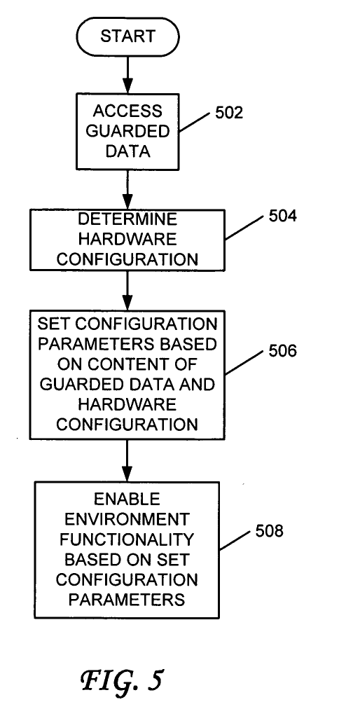

FIG. 5 illustrates a flowchart of another exemplary process that may be performed via system software executing on a processing device such as, for example, processing device 100, upon startup or after having been restarted after performing act 214 or 316. In embodiments in which the system software may detect changes to the guarded data without restarting, the processing device executing the system software may perform the exemplary process illustrated in FIG. 5 after the system software detects the changes to the guarded data. The processing device executing the system software may access the guarded data (act 502). In one embodiment, the processing device executing the system software may access registry keys, which may indicate a desired behavior and/or a desired set of services of the system software.

Next, the processing device executing the system software may determine its hardware configuration (act 504). The processing device may then set configuration parameters of the system software based on content of the guarded data and on the determined hardware configuration of the processing device (act 506). In one embodiment, the processing device executing the system software may further alter the guarded data based on the determined hardware configuration. The processing device may set configuration parameters such as, for example, registry keys or other configuration parameters which may affect behavior of the system software and services provided by the system software.

Next, the processing device may enable a particular environment functionality based on the set configuration parameters (act 508). In an embodiment, the processing device executing the system software may accomplish this by enabling a particular set of services, and/or a particular user interface or user interface experience. For example, services which provide for sharing of network resources may be enabled in the particular environment functionality of the system software.

Thus, in an embodiment which performs the process illustrated by FIG. 5, a user may be executing an operating system such as, for example, OS-Basic, on a processing device. The user may add memory/RAM to the processing device and may reboot the processing device. The system software executing on the processing device may detect the altered hardware configuration (increased memory), which may cause the system software to set configuration parameters and/or alter the guarded data to change, or enhance the capabilities of the system software executing on the processing device. For example, the processing device may now execute a more advanced operating system such as, for example, OS-Complex.

The above-described embodiments permit system software to be upgraded or downgraded. Changes to the environment functionality of the system software, such as upgrades, may be performed in a fraction of the time required to perform conventional upgrades to the system software. Further, the above-described embodiments permit the system software to be easily downgraded to a less advanced or less complex system for less sophisticated users or for operation on more basic hardware.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above description may contain specific details, they should not be construed as limiting the claims in any way. Other configurations of the described embodiments are part of the scope of this disclosure. Further, implementations consistent with the subject matter of this disclosure may have more or fewer acts than as described, or may implement acts in a different order than as shown. For example, with respect to the exemplary process illustrated by FIG. 3, act 314 may be performed before act 312, or with respect to the exemplary process illustrated by FIG. 2, act 206 may be performed before act 204. Accordingly, the appended claims and their legal equivalents should only define the invention, rather than any specific examples given.

We claim as our invention:

1. A method for altering a state of system software to change an environment functionality of the system software, the method comprising:
receiving state change information for altering the state of the system software; and
altering guarded data based on the state change information, the environment functionality of the system software being based on content of the guarded data.

2. The method of claim 1, further comprising restarting the system software after the altering of the guarded data, the restarted software system having the changed environment functionality.

3. The method of claim 1, wherein the changed functionality includes an increase in environment functionality of the system software.

4. The method of claim 1, wherein the changed functionality includes a decrease in environment functionality of the system software.

5. The method of claim 1, wherein the system software with the changed environment functionality includes no new or changed executable files with respect to the system software before the receiving of the state change information.

6. The method of claim 1, further comprising:
determining a hardware configuration of a processing device executing the system software;
setting configuration parameters based on at least one of the guarded data or the determined hardware configuration; and
enabling the environment functionality based on the set configuration parameters.

7. The method of claim 1, further comprising:
setting configuration parameters, by the system software to enable environment functionality based on the altered guarded data, the environment functionality including a particular user interface and a particular set of services.

8. A computer-readable medium having instructions recorded thereon for at least one processor, the computer-readable medium comprising:
instructions for prompting a user for state change information to be used for altering a state of system software;
instructions for receiving the state change information from the user; and
instructions for altering guarded data within the system software based on the state change information.

9. The computer-readable medium of claim 8, further comprising:
instructions for verifying a current state of the system software;
instructions for determining whether the current state of the system software is compatible with the received state change information; and
instructions for permitting the guarded data to be altered only when the current state of the system software is compatible with the received state change information.

10. The computer-readable medium of claim 8, wherein the system software having the altered guarded data includes no new or changed executable files.

11. The computer-readable medium of claim 8, wherein the system software is an operating system.

12. The computer-readable medium of claim 8, wherein:
the system software is an operating system, and
the instructions for altering guarded data included within the system software based on the state change information are included within a second operating system.

13. The computer-readable medium of claim 8, wherein the changed environment functionality is an increase in an environment functionality with respect to the system software.

14. The computer-readable medium of claim 8, wherein the changed environment functionality is a decrease in an environment functionality with respect to the system software.

15. The computer-readable medium of claim 8, wherein the changed environment functionality includes a particular user interface and a particular set of services based on the altered guarded data.

16. A computer-readable medium having instructions recorded thereon for at least one processor, the computer-readable medium comprising:
instructions for altering guarded data included in an operating system having a plurality of states, each of the plurality of states being associated with a different one of a plurality of environment functionalities; and
instructions for executing the software for altering guarded data based on provided state change information.

17. The computer-readable medium of claim 16, further comprising:
instructions for installing, on a processing device, the instructions for altering the guarded data included in an operating system.

18. The computer-readable medium of claim 16, wherein:
the operating system includes instructions such that, upon startup, the operating system configures itself to have a particular environment functionality, including a particular user interface and particular enabled services based on at least one of content of the altered guarded data or a determined hardware configuration.

19. The computer-readable medium of claim 16, wherein:
the operating system includes instructions such that, upon startup, the operating system configures itself, with no new or altered executable files, to have a particular environment functionality, including a particular user interface and particular enabled services based on content of the altered guarded data.

20. The computer-readable medium of claim 16, further comprising:
instructions for determining compatibility of a current state of the operating system with the provided state change information, wherein
the instructions for executing the software for altering guarded data executes only when the current state of the operating system is determined to be compatible with the provided state change information.
